(19) United States
(12) Patent Application Publication
(10) Pub. No.: US 2006/0163292 A1
(43) Pub. Date: Jul. 27, 2006

(54) Riser tube for a barrel

(76) Inventors: Albert Wauters, Destelbergen (BE); Hans Donker, Eindhoven (NL); Ian Anderson, Burwell (GB); Stephen J. Grimwade, Upwood (GB); Andrew R. B. Halket, Cherry Hinton (GB)

Correspondence Address: James W Kerr;Interbrew SA, 303 Richmond Street, London, ON, N6B 2H8, CA

(21) Appl. No.: 10/536,975

(22) PCT Filed: Nov. 25, 2003
(86) PCT No.: PCT/IB03/05404

§ 371 Date: Dec. 20, 2005

(30) Foreign Application Priority Data
Nov. 29, 2002 (GB) 0227935.4
Nov. 29, 2002 (GB) 0227936.2

(51) Int. Cl. B67D 5/60

(52) U.S. Cl. 222/464.2; 222/105

(57) ABSTRACT

An alcohol beverage dispensing apparatus has a keg having top and bottom portions and a bag contained within the keg for containing an alcohol beverage. The apparatus has a dispensing device that has a hollow elongated tube extending into the bag towards the bottom portion of the keg for inserting the beverage into the bag during a bag fill operation and for dispensing the beverage from the bag during a dispense operation. The hollow tube has an end portion having an opening which may comprise a plurality of laterally spaced apart notches positioned between interval side wall portions to provide crenellated openings in the end portion throughwhich the beverage passes into and out from the hollow elongated member. The interval side wall portions have rounded tip portions or carry an interface plate to reduce the risk of the end portion puncturing the bag during beverage filling and dispensing cycles. Further, the hollow elongated member further may have at least one additional aperture therein spaced apart from the opening to receive beverage in through the at least one aperture during a dispense cycle, which beverage mixes with beverage from the opening prior to dispensing. This mixing of the beverage results multiple servings of beverage dispensed by the dispensing device being at a more homogenous temperature.

### FIELD OF THE INVENTION

The present invention relates to an alcohol beverage dispensing apparatus for dispensing the beverage from a bag.

### BACKGROUND OF THE INVENTION

In some applications it is known to store alcohol beverages in plastic bags. In home beer dispensing apparatus, beer is filled into and dispensed from a plastic bag that is housed in a metallic keg. A dip tube extends into the bag for filling and dispensing the beer.

During dispensing the bag deflates and there is a possibility that the bag may be drawn into contact with the dip tube. This is especially a problem when the bag is nearly empty of its contents. As a consequence of the bag contacting the dip tube, beverage may be prevented from passing into the dip tube or may result in the bag rupturing or tearing against the dip tube. Once a bag tears, there is internal leakage and the bag can no longer be recycled. Also, as a practical matter, beer can no longer be urged out of the keg and dispensed.

Moreover, the home beer dispensing apparatus typically house smaller kegs containing anywhere from five to six liters of beer. Because of the environment, it is common that the beer is not refrigerated prior to insertion into the home dispensing apparatus. In the home dispensing system the beer keg is preferably cooled or chilled from the base of the keg. This results in a temperature stratification effect where the beer at the bottom of the keg is cooler than the beer at the top of the keg prior to the cooling cycle for the beer keg reaching a desired serving temperature.

This stratification in initial cooling presents a problem to a consumer wishing to draw multiple servings of beer from the dispenser prior to all the beer contained within the keg reaching the desired serving temperature because subsequent servings are warmer. Hence, there is a need to provide dispensing device that reduces the problems associated with beer temperature stratification.

### SUMMARY OF THE INVENTION

It is an object of the present invention to provide a dispensing member for dispensing an alcohol beverage from a bag that is not subject to disturbances in flow rate of beverage being dispensed when the bag comes into contact with the dispensing member.

It is an object of the present invention to provide a dispensing member for dispensing an alcohol beverage from a bag that reduces risk of the bag rupturing should the bag come into contact with the dispensing member.

It is a further object of the present invention to provide an alcohol beverage dispensing apparatus that dispenses multiple servings of the beverage at a more homogeneous temperature prior to the beverage being cooled to its desired serving temperature.

In one embodiment, the present invention relates to a dispensing device for a bag containing an alcohol beverage. The device has a hollow elongated member adapted to extend into the bag. The hollow elongate member preferably has an end portion having a plurality of laterally spaced apart notches providing openings through which the beverage passes. The lateral spaced notches permit fluid flow into the end portion of the device in the event the bag contacts the end portion.

It is envisaged that the end portion has interval side wall portions between adjacent notches which wall portions have rounded tip portions to reduce the chances of the end portion puncturing the bag. Alternatively, the end portion may have a closed end to reduce the risk of bag puncture. It is envisaged that the end portion may have a spherical shape or a bell bottom shape. Alternatively, a base plate may be provided to isolate the bag from the end portion.

In a further embodiment, the dispensing device comprises a hollow elongated member having an end portion which is open or has openings to allow passage of beverage and at least one (additional) aperture in the elongated member spaced apart from the open end or openings, whereby the beverage entering the open end is mixed with the beverage entering through the at least one aperture which is at a warmer temperature prior to the beverage being chilled to its desired serving temperature. This mixing of the beverage results in multiple servings of beverage dispensed by the dispensing device being at a more homogenous temperature.

Preferably the member has a plurality of apertures, the size and shape of which are proportional to the size of the open end of the member to provide a desired temperature mixture of the beverage in the member prior to dispensing. Preferably a plurality or series of these apertures are laterally spaced about the member.

Preferably the dispensing member comprises an elongated hollow tube. The tube may comprise a metal or hard or relatively rigid plastic material, so long as it maintains its elongated shape.

Preferably, the alcohol beverage dispensing device is utilized in a home beer dispensing apparatus.

In accordance with one aspect of the present invention there is provided a dispensing device for a bag containing an alcohol beverage. The dispensing device comprises a hollow elongated member adapted to extend into the bag. The hollow elongated member has an end portion having a plurality of laterally spaced apart notches providing openings in the end portion throughwhich the beverage passes into the hollow elongated member.

In accordance with another aspect of the present invention there is provided a dispensing device for a bag containing an alcohol beverage. The dispensing device comprises a hollow elongated member adapted to extend into the bag. The hollow elongate member has an end portion having an opening for receiving the beverage during a dispense cycle. The hollow elongated member further includes at least one additional aperture therein spaced apart from the open end to receive the beverage into the member during the dispense cycle, whereby the beverage entering the open end is mixed with the beverage entering through the at least one aperture.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is a side sectional view of the keg shown inside the beer dispensing apparatus of FIG. 2 having a dip tube extending into the bag of the keg;

FIG. 4 is an enlarged view of a preferred embodiment of the tip portion of the dip tube;

FIG. 5 is an enlarged view of an alternative embodiment of the tip portion of the dip tube; and,

FIG. 6 is an enlarged view of a further alternative embodiment of the tip portion of the dip tube.

### DETAILED DESCRIPTION OF THE INVENTION

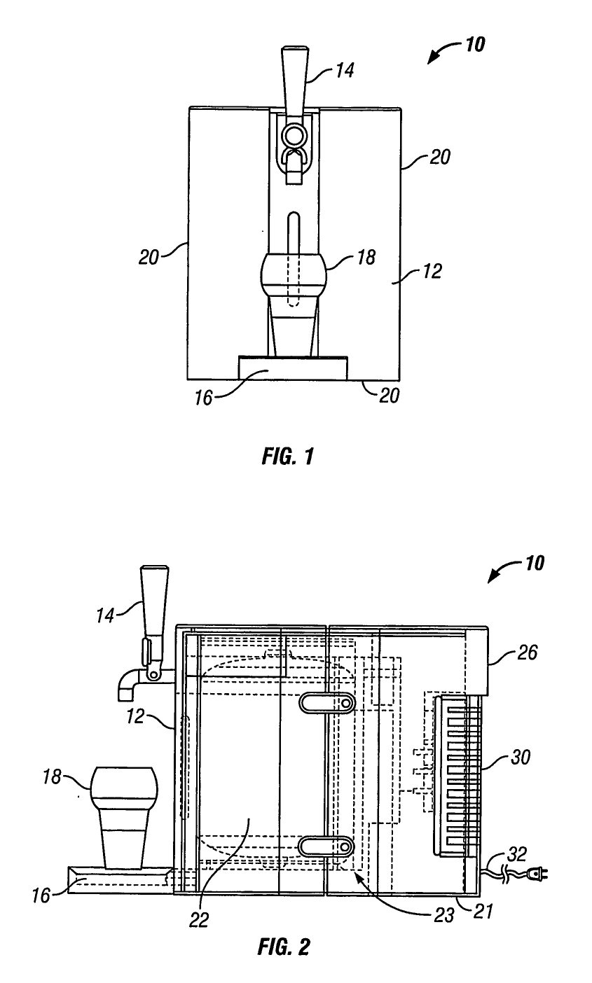

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top in a kitchen. The front wall 12 is formed as an extension of two pivoting side walls 20 which may be moved between closed and open positions to allow the keg 22 (see FIG. 2 in broken lines) to be inserted into the housing of the home beer dispensing apparatus 10. The housing of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the dispensing apparatus 10. Alternatively, a 12 Volt DC supply input may be used.

The dispensing apparatus 10 has a cooling system 23 located behind and below keg 22 that is adapted to cool the keg 22 of beer when placed in dispensing apparatus 10. The dispensing apparatus 10 also dispenses the beer by providing a pressurized air supply (not shown).

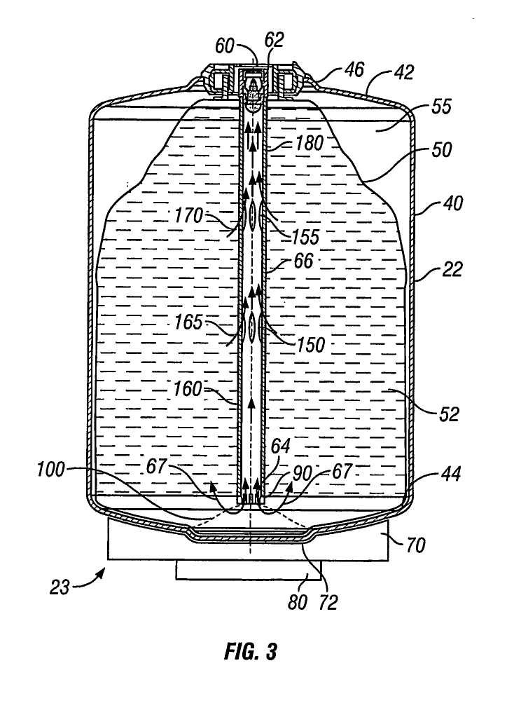

Referring to FIG. 3, the cooling of the keg 22 within the beer dispensing apparatus 10 is accomplished by a cooling apparatus 23 comprising cooling plate 70 having a cooling surface 72 that in the preferred embodiment is in mechanical and heat transfer contacting relation with the bottom portion of the keg 22 for extracting heat from the beer 52.

The cooling apparatus further includes a Peltier thermoelectric device 80 mounted in mechanical and thermal heat transfer contacting relation with the cooling plate 70. The Peltier thermoelectric device 80 is connected through a suitable leads and transformer (not shown) to the power supply line or cord 32 (see FIG. 2) so that a voltage is applied across the Peltier thermoelectric device 80.

Keg 22 has a general cylindrical shape with side walls 40 and a top wall or top portion 42 and a bottom wall or bottom portion 44. Both top wall 42 and bottom wall 44 are curved upwardly from the central portion of the keg 22 and are provided with a raised annular collar 46. The collars 46 provide additional support for the keg 22.

Mounted within the keg walls 40, 42 and 44 is a plastic bag 50 for containing alcohol beverage which in the preferred embodiment is beer 52.

As shown in FIG. 3, the keg is filled with beer 52 within the bag 50 and as a result the bag 50 lines the inside walls of the keg 22. As the beer 52 is dispensed from the keg 22, an air pressure is established between the walls of the bag 50 and the inside surfaces of walls 40, 42 and 44 of the keg so as to provide pressure to the bag 50 allowing the beer 52 to be dispensed from the keg 22. The air pressure space is shown at 55.

The top portion 42 and collar 46 located in the top portion 42 of keg 22 has a keg dispensing device or valve 60 extending through the top collar 46. The keg dispensing device 60 is connected to the tap 14 of the beer dispensing apparatus 10 by a tube or tap connection (not shown) extending from the keg dispensing device 60 at its top end 62.

The dispensing device 60 has a dip tube 66 that extends into the keg 22 within bag 50 so as to provide a remote open end or tip portion 64 adjacent the bottom portion 44 of the keg for drawing beer 52 from the bottom portion 44 of the keg 22. Beer 52 is drawn through open end 64, up hollow tube 66 out through end 62 to the tap 14 (FIG. 1). For filling, the beer is inserted through valve end 62 down the tube 66 and out end 64 into bag 50. The dual direction flow of beer 52 into and out through end portion 64 is illustrated by arrows 67 in FIG. 3.

In this first described embodiment, the tube 66 is continuous, that is, beer may only enter through open end 64; there are no additional apertures located along the length of the wall of the tube 66.

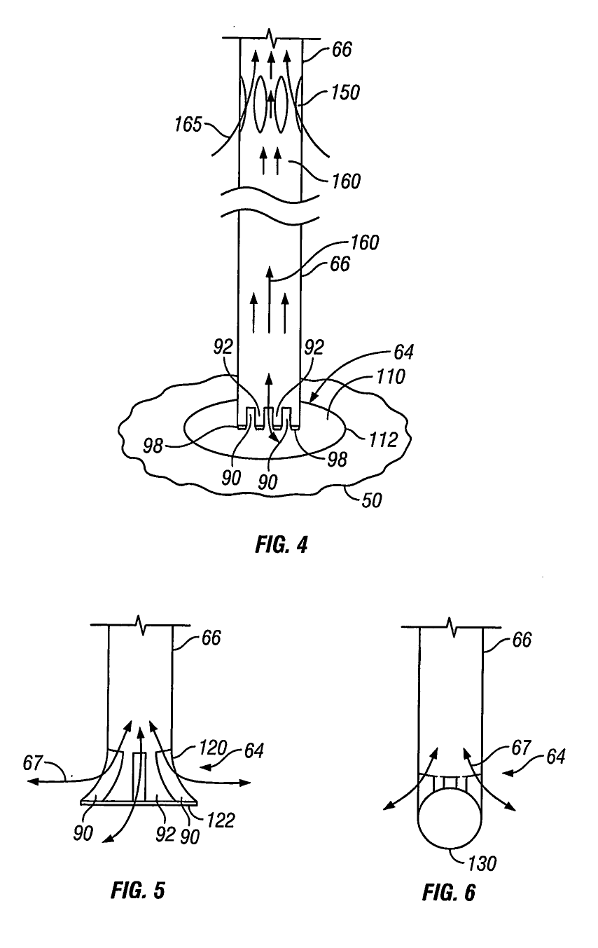

Referring to FIGS. 3 and 4, the end potion 64 of the tube 66 has a plurality of laterally spaced apart notches 90 which are positioned between interval side wall portions 92. The notches 90 in effect provide crenellated openings or apertures in the end portion 64 through which the beer 52 passes into and out from the hollow tube 66. As best shown in FIG. 4, the interval side wall potions 92 have rounded tip portions 98.

It should be understood that the tube 66 is an elongated cylindrical member wherein the side wall has the crenellated openings 90 so as to form an inverse battlement shape or structure. The purpose of the openings or notches 90 is to permit for the beverage to pass into the tube 66 when pressure in space 55 pushes bag 50 into contacting relation with end portion 64 of the tube 66. This contacting relation is shown by broken line 100 in FIG. 3. It should be noted in FIG. 3 that the end portion 64 is spaced a sufficient distance away from the bottom portion 44 of keg 22 and that in practice, the bag 50 will line the bottom portion 44 of keg 22. Hence, the representation of line 100 of the bag coming into contact with the base or end portion 64 of the tube 66 is more likely to occur in conditions where there is considerably less beer 52 contained in the bag 50 than the amount of beer that is illustrated in FIG. 3.

The advantage of the rounded tip portions 98 on the interval side wall portions 92 is to reduce the risk of the end portion 64 piercing the bag 50 during the dispensing operation. Further, the tips 98 reduce the risk of the end portion 64 piercing the bag 50 during the insertion of the tip or the tube 66 into the bag 50 prior to the bag 50 being filled with beer 52.

Referring to the lower part of FIG. 4, there is shown an alternate construction of an interface base plate 110 comprising a thin piece of metal. The base plate 110 is shown to have a circumference 112 that is larger than that of the tube 66, however, in practice the circumference 112 of base plate 110 may substantially correspond to the diameter of tube 66. The purpose of base plate 110 is to isolate the bag 50 from the end portion 64 of the tube 66. In one aspect of the present invention, it is envisaged that the support plate 110 forms a part of the end portion 64 thereby closing off the otherwise opened end of the end portion 64. Alternatively, the base plate 110 may form a portion of, or be laminated to, the bag 50. The purpose of the base plate 110 is to prevent piercing of the bag 50 by the end portion 64 of the tube 66.

Referring to FIG. 5, there is shown an alternative embodiment for the end portion 64 of the dip tube 66. In this embodiment the end portion 64 has an outwardly flared end tip portion 120. This outwardly flared tip portion is a bell bottomed shape. This particular shape, while having the advantages associated with the tip portion 64 shown in FIG. 4, also has the advantage that when beer is dispensed into the bag, beer has a tendency to flow laterally out the ends of the notches 94 due to the bell shape 120 having a closed end 122. This results in the displacement of beer flowing into the bag to be a more even distribution. This more even distribution reduces carbon dioxide pockets forming in the bag during a bag beer fill operation.

Referring to FIG. 6 there is shown an alternative embodiment wherein the end portion 64 has a spherical shape 130. The spherical shape 130 prevents bag perforation during the insertion of the tube 66 into the bag 50 and during the dispensing of beer from the bag 50.

In the immediately above described embodiments, the tube 66 has an aperture or apertures allowing beer to pass only into the end portion 64 of tube 66.

Referring again to FIGS. 3 and 4, especially the upper part thereof, there is shown a further embodiment of the invention where the tube 66 is further provided with a first series (i.e. a plurality) of laterally spaced apertures 150 and a second series of laterally spaced apertures 155. These series are spaced from the end 64 of the tube and further away from the base of the bag 50 than end 64. The laterally spaced apertures 150 and 155 are sized and shaped so as to mix beer entering the open end 64 and moving up the tube 66 as represented by arrows 160 with beer entering apertures 150 and 155 as represented by arrows 165 and 170.

It should be understood that only one series of laterally spaced apertures may be provided in this preferred embodiment as opposed to two shown in FIG. 3. The distance between the apertures 165 and the end portion 64 of the tube 66 should be sufficient that beer 52 contained in bag 50 at different temperatures due to the initial stratification temperature effect is adequately mixed to a more homogeneous temperature which is dispensed out of the top end 62 of the dispensing device 60. This mixture of beer is represented by arrows 180 shown towards the top portion of tube 66 in FIG. 3. Hence the provision of the apertures of 150 and 155, together with the open end 64 of the tube 66 allows for respectively warmer and colder beer to be mixed and dispensed at a more homogeneous temperature in the event there are multiple servings required from the keg 22 by a consumer prior to the beer 52 in the keg 22 being chilled to its desired serving temperature.

What is claimed is:

1. A dispensing device for a bag containing an alcohol beverage, the dispensing device comprising:
a hollow elongated member adapted to extend into the bag, the hollow elongate member has an end portion having an opening for receiving the beverage during a dispense cycle, the hollow elongated member further including at least one aperture therein spaced apart from the opening to receive the beverage into the member during the dispense cycle, whereby the beverage entering the opening is mixed with the beverage entering through the at least one aperture.

2. The device of claim 1 wherein the member has a plurality of such apertures, the size and shape of which are proportional to the size of the opening of the member to provide a desired mixture of the beverage in the member prior to dispensing.

3. The device of claim 3 wherein a plurality of said apertures are laterally spaced about the member.

4. The device of claim 1 wherein more than one plurality of apertures are spaced along the member.

5. The device of claim 1 wherein the end portion has a plurality of laterally spaced apart notches providing openings in the end portion through which the beverage passes into and out from the hollow elongated member and respectively out from and into the bag.

6. The device of claim 1 wherein the hollow elongated member comprises a tube.

7. An alcohol beverage dispensing device comprising:
a keg having top and bottom portions;
a bag contained within the keg for containing an alcohol beverage; and,
a dispensing device comprising a hollow elongated member extending into bag towards the bottom portion of the keg, the hollow elongate member has an end portion having an opening for receiving the beverage during a dispense cycle, and the hollow elongated member further including at least one aperture therein spaced apart from the opening to receive the beverage into the member during the dispense cycle, which beverage mixes with beverage from the opening prior to dispensing.

8. The device of claim 7 wherein the hollow elongated member comprises a tube.

9. The device of claim 7 wherein the member has a plurality of apertures, the size and shape of which are proportional to the size of the open end of the member to provide a desired mixture of the beverage in the member prior to dispensing.

10. The device of claim 7 wherein a plurality of said apertures are laterally spaced about the member.

11. The device of claim 7 wherein more than one plurality of apertures are spaced along the member.

12. The device of claim 7 wherein the end portion has a plurality of laterally spaced apart notches providing openings in the end portion through which the beverage passes into and out from the hollow elongated member and respectively out from and into the bag.

13. A dispensing device for a bag containing an alcohol beverage, the dispensing device comprising:
a hollow elongated member adapted to extend into the bag, the hollow elongated member has an end portion having a plurality of laterally spaced apart notches providing openings in the end portion throughwhich the beverage passes into the hollow elongated member.

14. The device of claim 13 wherein the end portion of the hollow elongated member is open.

15. The device of claim 13 wherein the notches form crenellated openings.

16. The device of claim 13 wherein the hollow elongated member comprises a tube.

17. The device of claim 13 wherein the end portion has interval side wall portions between adjacent notches which portions have rounded tip portions.

18. The device of claim 13 further including an interface base plate extending between the end portion and the bag to isolate the bag from the end portion.

19. The device of claim 18 wherein the end portion has interval side walls portion between adjacent notches and the base plate is attached to the side wall portions to close the end portion of the hollow elongated member.

20. The device of claim 18 wherein the base plate forms part of the bag.

21. The device of claim 20 wherein the end portion has a bell bottom shaped wall.

22. The device of claim 13 wherein the end portion has a spherical shape.

23. An alcohol beverage dispensing apparatus comprising:
a keg having top and bottom portions;
a bag contained within the keg for containing an alcohol beverage; and,
a dispensing device comprising a hollow elongated member extending into the bag towards the bottom portion of the keg for inserting the beverage into the bag during a bag fill operation and for dispensing the beverage from the bag during a dispense operation, and the hollow elongated member having an end portion having a plurality of laterally spaced apart notches providing openings in the end portion throughwhich the beverage passes into and out from the hollow elongated member.

24. The device of claim 23 wherein the hollow elongated member comprises a tube.

25. The device of claim 24 wherein the end portion of the hollow elongated member is open.

26. The device of claim 24 wherein the notches form crenellated openings.

27. The device of claim 24 wherein the end portion has interval side wall portions between adjacent notches which portions have rounded tip portions.

28. The device of claim 24 further including an interface base plate extending between the end portion and the bag to isolate the bag from the end portion.

29. The device of claim 28 wherein the end portion has interval side wall portions between adjacent notches and the base plate is attached to the side wall portions to close the end portion of the hollow elongated member.

30. The device of claim 28 wherein the base plate forms part of the bag.

31. The device of claim 23 wherein the end portion has a bell bottom shaped wall.

32. The device of claim 23 wherein the end portion has a spherical shape.
